(19) United States
(12) Patent Application Publication
(10) Pub. No.: US 2007/0150249 A1
(43) Pub. Date: Jun. 28, 2007

(54) Verification Operation Supporting System and Method of the Same

(75) Inventor: Noriaki Asamoto, Shiga (JP)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/608,885

(22) Filed: Dec. 11, 2006

(30) Foreign Application Priority Data
Dec. 26, 2005 (JP) 2005-371566

(51) Int. Cl. G06F 17/50

(52) U.S. Cl. 703/14

(57) ABSTRACT

A verification operation supporting system which can automatically execute complicated verification operation is provided. This system is provided with an input device for an administrator for inputting test case common information common to all test cases and test case difference information different for every test case, a text editor for generating a template file containing basic information and, an input device for a verification person for inputting verification person individual information and test condition individual information, a parameter file automatic generating program for generating test case information file which describes the verification operation of each test case by adding individual information and to the basic information and in the template file, and a verification operation executing program for executing the verification operation in accordance with the test case information file while running a TOS and an HDL simulator.

### FIELD OF THE INVENTION

The present invention relates to a verification operation supporting system, and more particularly to a verification operation supporting system for supporting verification operation to validate one or more design data by one or more test cases using a simulator.

### BACKGROUND OF THE INVENTION

An SOC (System On Chip) is a semiconductor integrated circuit in which not only a core processor but also a highly efficient peripheral device, such as a USB (Universal Serial Bus) host controller or a PCI (Peripheral Component Interconnect) bus controller, are integrated in one chip. In development of the SOC, design data is verified based on a logic simulation. Verification operation of the SOC is performed by repeating cycles for every test case, with one cycle including organization of a test environment, generation of a test code, and execution of simulation.

The organization of the test environment is performed by each verification person (person in charge of verification) who manually organizes his/her own working environment for every test case based on a test bench shared in an SOC development project. Specifically, the verification person generates a working directory for temporarily storing a file for simulation to and from which an HDL (Hardware Description Language) simulator outputs and inputs for every test case, and copies necessary files therein. Since the working directory is generated on a local host of the verification person in order to increase the speed, the working environments are different for every verification person.

The generation of the test code is considerably complicated in the case of the system logic verification of the SOC, namely, the logic verification performed on the whole SOC chip. For that reason, an existing verification tool, such as a TOS (Test Operating System) disclosed in U.S. Pat. No. 6,658,633, Automated system-on-chip integrated circuit design verification system, herein incorporated in its entirety by reference, for example, is required. The generation of the test code requires many parameters, which are described in a system definition file (SDF) in the case of the TOS. Generally, it is believed that the generation of the test code requires some means corresponding to the SDF.

The execution of the simulation is performed by reading the generated test code by the TOS and inputting it to the HDL simulator. Since not all the test cases can be verified at a time by one test code in the actual operation, a plurality of system definition files must be prepared and the simulation be executed for a plurality of times. In addition, since the system definition files would be modified as the development of the SOC progresses, all the system definition files must be modified whenever a common part of the system definition files is partially modified to generate the test code again. Moreover, there is a case in which even when a source code or the like is not changed, the test code may be generated again and the simulation may be executed again. This is because one test code is in fact constituted by a number of test cases and an execution pattern of each test case contained in one test code is changed at random.

Each verification person has to manually perform necessary pre-processing and post-processing before and after the simulation. Specifically, before executing the simulation, each verification person copies a necessary related file or changes simulation conditions for every test case according to his/her own work environment. After executing the simulation, each verification person generates a simulation result report.

In the system logic verification of the SOC, in order to verify the cooperated operation between respective IP (Intellectual Property) cores, the test bench contains models of all the peripheral devices, and the test code contains initialization codes of all the peripheral devices. When the verification person in charge of the USB core changes the test bench or the setup, it must be reflected also in verification environment of the verification person in charge of the PCI core.

As can be seen from the foregoing detailed description, in order to verify the design data of the SOC, a large amount of complicated manual works must be performed before generating the test code as well as before and after the simulation. For that reason, the verification operation takes a long time, and confusion or mistake is likely to occur. Although the simulation itself tends to be sophisticated, the system that automates such a large amount of complicated manual works has not yet been provided. Therefore there is a need for a verification operation supporting system which can automatically execute a complicated verification operation.

### SUMMARY OF THE INVENTION

An object of the present invention is to provide a verification operation supporting system which can automatically execute a complicated verification operation.

A verification operation supporting system, according to the present invention, for supporting verification operation to verify one or more design data by one or more test cases using a simulator, comprises a basic information input, a template file generator, a individual information input, a parameter file generator, and a verification operation executor. The basic information input is configured to receive input of basic information necessary to specify the test case. The template file generator generates a template file including the basic information inputted by the basic information input. The individual information input receives input of individual information necessary to specify an item other than the test case. The parameter file generator generates a parameter file necessary for the verification operation by reading the basic information from the template file and adding the individual information inputted by the individual information input to the basic information. The verification operation executor means executes the verification operation in accordance with the parameter file while running the simulator.

According to the verification operation supporting system, only by the action that an administrator inputs the basic information (such as a procedure of the verification operation for each test case) and a verification person in charge inputs the individual information (such as a path for indicating a location of a working directory or design data), the parameter file of each test case is generated, so that a complicated verification operation can be automatically executed by executing the simulation in accordance with the parameter file.

The basic information includes test case common information common to a plurality of test cases, and a plurality of pieces of test case difference information, each test case difference information being different for every test case.

In this particular embodiment, the data size of the template file can be reduced, and also the rewritten pieces of test case common information can be reflected to the parameter file of each test case.

The parameter file generator generates the test case information file for each test case by adding the test case difference information corresponding to each test case to the test case common information. The parameter file includes a plurality of test case information files corresponding to a plurality of test cases.

The individual information includes path information for indicating a location of the design data to be verified. The parameter file generator generates the test case information file for each test case by adding the path information inputted by the individual information input. Each of the test case information file includes the path information.

### BRIEF DESCRIPTION OF THE DRAWINGS

FIG. 1 is a functional block diagram illustrating a configuration of a verification operation supporting system according to an embodiment of the present invention.

FIG. 2 illustrates a data structure of a template file in FIG. 1.

FIG. 3 is an example of the template file illustrated in FIG. 2.

FIG. 4 illustrates a data structure of a parameter file in FIG. 1.

FIG. 5 illustrates a data structure of a test case information file in the parameter file illustrated in FIG. 4.

FIG. 6 is an example of the test case information file illustrated in FIG. 5.

FIG. 7 is a flow chart illustrating operation of the verification operation supporting system (a verification operation supporting method and a program product thereof) illustrated in FIG. 1.

FIG. 8 is a flow chart illustrating a subroutine of parameter file generation processing in FIG. 7.

FIG. 9 illustrates a generation method of the test case information file by a parameter automatic generating program in FIG. 1.

FIG. 10 is a flow chart illustrating the subroutine of verification operation execution processing in FIG. 7.

FIG. 11 is an example where a content of the verification operation automatically executed by the verification operation supporting system illustrated in FIG. 1 is changed for every test case.

### DETAILED DESCRIPTION

Hereinafter, embodiments of the present invention will be described in detail with reference to the drawings. Similar numerals are given to similar or equivalent parts throughout the drawings, and the description thereof will not be repeated.

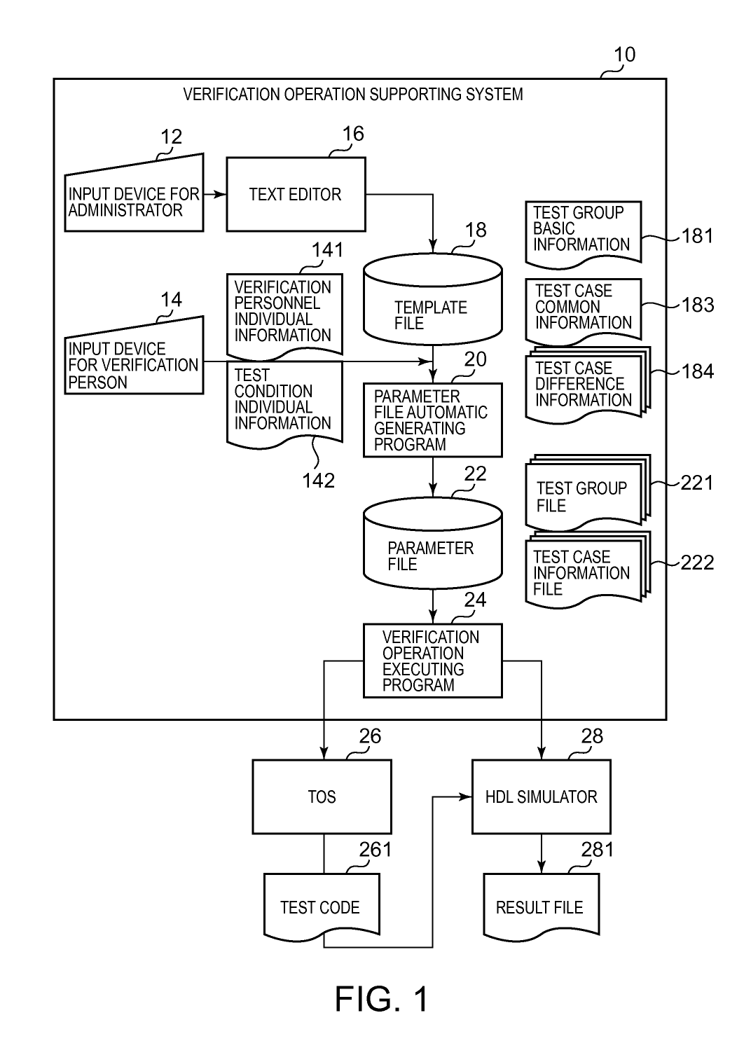

Referring to FIG. 1, a verification operation supporting system 10 according to the embodiment of the present invention is provided with an input device for an administrator 12, an input device for a verification person (person in charge of verification) 14, a text editor 16, a template file 18, a parameter file automatic generating program 20, a parameter file 22, and a verification operation executing program 24.

The verification operation supporting system 10 supports verification operation to verify one or more design data of an SOC by one or more test cases which have been prepared preliminarily using a TOS (Test Operating System) 26 and an HDL simulator 28. The TOS 26 is one of the existing verification tools for automatically generating a test code 261 based on a system definition file (SDF), which is disclosed in detail in the specification of U.S. Pat. No. 6,658,633, Automated system-on-chip integrated circuit design verification system. The HDL simulator 28 executes a simulation of the design data using the test code 261 and outputs a simulation result report 281. Although an example using the TOS 26 is described herein, any verification tool corresponding to the TOS 26 may be used instead of it.

The text editor 16, the parameter file automatic generating program 20, and the verification operation executing program 24 are all computer programs, and function as modules in the verification operation supporting system 10. The programs 16, 20, and 24, and the files 18 and 22, are stored in a storage medium such as a hard disk.

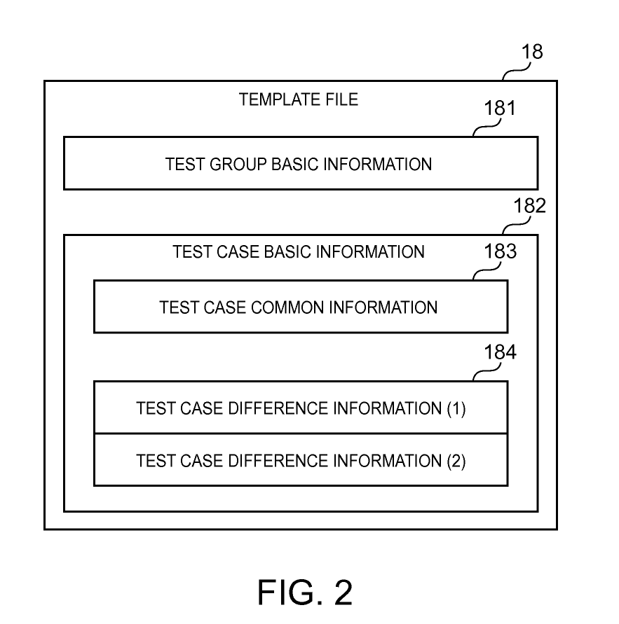

The input device for the administrator 12 receives input of basic information to be described in the template file 18 in accordance with the manipulation of the administrator. The template file 18 includes, as illustrated in FIG. 2, test group basic information 181 necessary to specify a test group and test case basic information 182 necessary to specify a test case. The test case basic information 182 includes test case common information 183 common to a plurality of test cases and a plurality of pieces of test case difference information 184 different for every test case. Since the test case basic information 182 is shared by a plurality of test cases, the data size of the template file 18 is reduced.

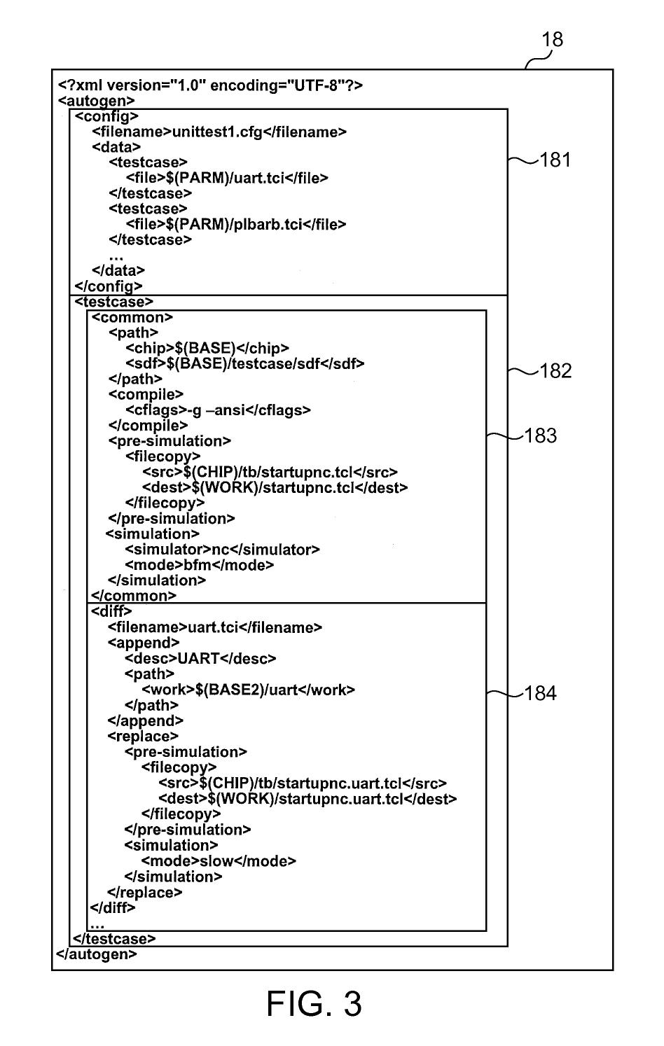

The template file 18 is described in the XML (extensible Markup Language) format. This is because the XML is easy to be handled since, for example, data is structured in the text format and an API (Application Program Interface) for data processing is standardized. By extending the API of the XML, it is also possible to uniquely extract the necessary data in accordance with a hierarchically managed node name and position information on a certain hierarchy (order of appearance). FIG. 3 illustrates an example of the template file 18.

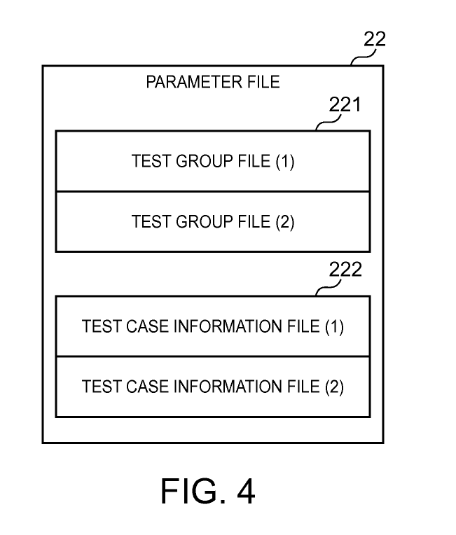

In the test group basic information 181, as illustrated in FIG. 3, basic information necessary for generating a test group file (reference numeral 221 in FIG. 4) in the parameter file 22 is described. In the test case common information 183, the basic information substantially common to all the test cases, specifically, information including the procedure of the verification operation or a test condition, is described. In each of the pieces of test case difference information 184, the information specific to the test case, specifically difference information (such as addition information, substitute information, or deletion information) including the procedure of the verification operation or the test condition, is described.

The addition information (part of <append> to </append> in FIG. 3) is the information which is not included in the test case common information 183, and the information to be added to the test case common information 183. The substitute information (part of <replace> to </replace> in FIG. 3) is the information included in the test case common information 183 and the information to be substituted. The deletion information is the information included in the test case common information 183, and the information to be deleted.

Referring again to FIG. 1, the input device for the verification person 14 receives input of individual information necessary to specify an item other than the test case, specifically, verification person individual information 141 and test condition individual information 142, in accordance with manipulation of the verification person 14. The verification person individual information 141 is the information different for every verification person, and the information relates to working environment, such as a working directory. The test condition individual information 142 is the information different for every test phase, and the path information for indicating a location of the design data of the SOC to be a target of the verification, and the information relates to a test mode (an IP core unit test mode, a random cooperative test mode, or the like) used for the verification.

The parameter file automatic generating program 20 generates the parameter file 22 necessary for the verification operation by reading the test group basic information 181 and the test case basic information 182 from the template file 18, and adding the verification person individual information 141 and the test condition individual information 142 to the pieces of basic information 181 and 182.

The parameter file 22 includes a plurality of test group files 221 and a plurality of test case information files 222, as illustrated in FIG. 4. Since the plurality of test cases are grouped for every execution pattern (a unit test, a cooperative test, or the like), the plurality of test group files 221 are generated corresponding to the plurality of execution patterns, and the plurality of test case information files 222 are then generated corresponding to each test group file 221. The parameter file 22 is also described in the XML format similarly to the template file 18.

In each test group file 221, a list of the plurality of corresponding test case information files 222 (specifically the path information for indicating the location of each test case information file 222) and setup information necessary for executing the verification operation executing program 24 or the like are described. The parameter file automatic generating program 20 generates the test group files 221 by reading the test group basic information 181 from the template file 18, and copying it to the parameter file 22.

The test case information files 222 are generated for every test case. In each test case information file 222, the procedure of the verification operation in the test case is described. The TOS 26 can execute the plurality of test cases sequentially or simultaneously, and generates one test code when the combined plurality of test cases are collectively compiled. Although executing one HDL simulation using one test code results in that the plurality of test cases are executed in fact, it is considered as one test case herein as they correspond to one test code.

The parameter file automatic generating program 20 generates the test case information file 222 for the test case by reading the test case common information 183 and the test case difference information 184 for the test case from the template file 18, and adding the test case difference information 184 for the test case to the test case common information 183.

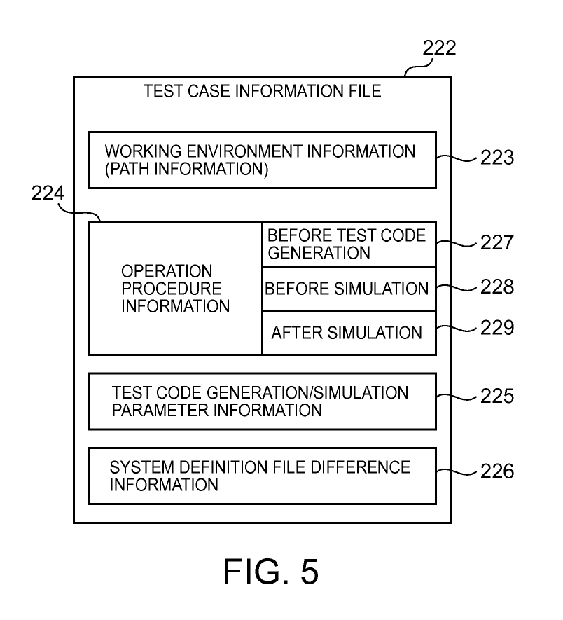

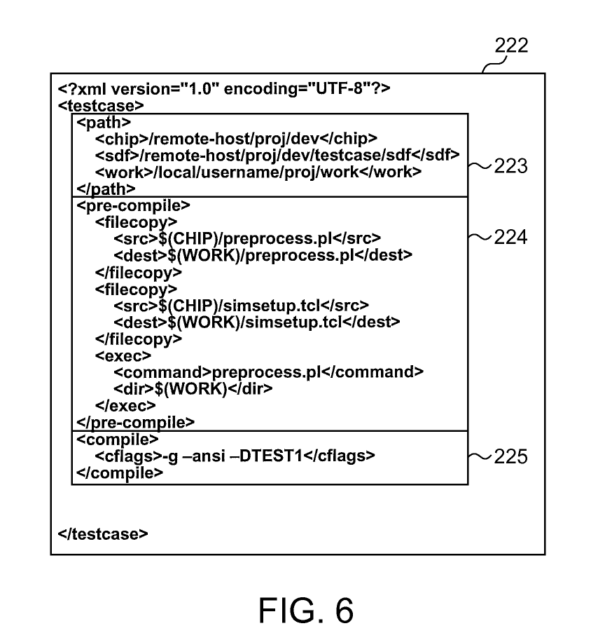

Each test case information file 222 includes, as illustrated in FIG. 5, working environment information (path information) 223, operation procedure information 224, test code generation/simulation parameter information 225, and system definition file difference information 226. FIG. 6 illustrates an example of the test case information file 222.

In the working environment information 223, the path information for indicating the location of the design data to be the target of the verification 223 (part of <chip> to </chip> in FIG. 6), the path information for indicating the location of the system definition file necessary for generation of the test code (part of <sdf> to </sdf> in FIG. 6), and the path information for indicating the location of the working directory of each verification person (part of <work> to </work> in FIG. 6) are described.

The operation procedure information 224 is constituted by operation procedure information before the test code generation 227, procedure information before the simulation 228, and procedure information after the simulation 229. In each of pieces of operation procedure information 227 to 229, the information of such as a copy source and a copy destination of the file to be copied, an external program to be executed (such as a script program expressed by “preprocess.pl” in <exec> to </exec> in FIG. 6), and its execution directory are described. The verification operation executing program 24 executes the external program in a sequence described here.

In the test code generation/simulation parameter information 225, a test code generation parameter to be given to the TOS 26 and a simulation parameter to be given to the HDL simulator 28 are described.

In the system definition file difference information 226, the difference information from the system definition file, as a base for generating the system definition file necessary in generation of the test code corresponding to the test case is described. Since the system definition file includes also the test code generation parameter or the like, it can be included in the test code generation/simulation parameter information 225, but it is distinguished from the test code generation/simulation parameter information 225 herein as it is not the parameter itself but the difference information of the system definition file.

Also, in the test case information file 222 illustrated in FIG. 6, part of <pre-compile> to </pre-compile> in lines 8 to 21 indicates the operation procedure before the generation (compile) of the test code. Parts of <filecopy> to </filecopy> in lines 9 to 12 and 13 to 16 indicate to copy a specified file before the generation of the test code. Part of <exec> to </exec>> in lines 17 to 20 indicates the external program to be executed before the generation of the test code. By changing these parts, any processing may be added. In addition, $(CHIP) in line 11 indicates to substitute this part with the part of <chip> to </chip> described above, while $(WORK) in line 12 indicates to substitute this part with the part <work> to </work> described above. In this example, there is described that the script program named “preprocess.pl” is copied to the working directory to be executed, for example.

Referring again to FIG. 1, the verification operation executing program 24 automatically executes the verification operation in accordance with the parameter file 22 while running the TOS 26 and the HDL simulator 28.

Next, the operation of the above-described verification operation supporting system 10 will be now described.

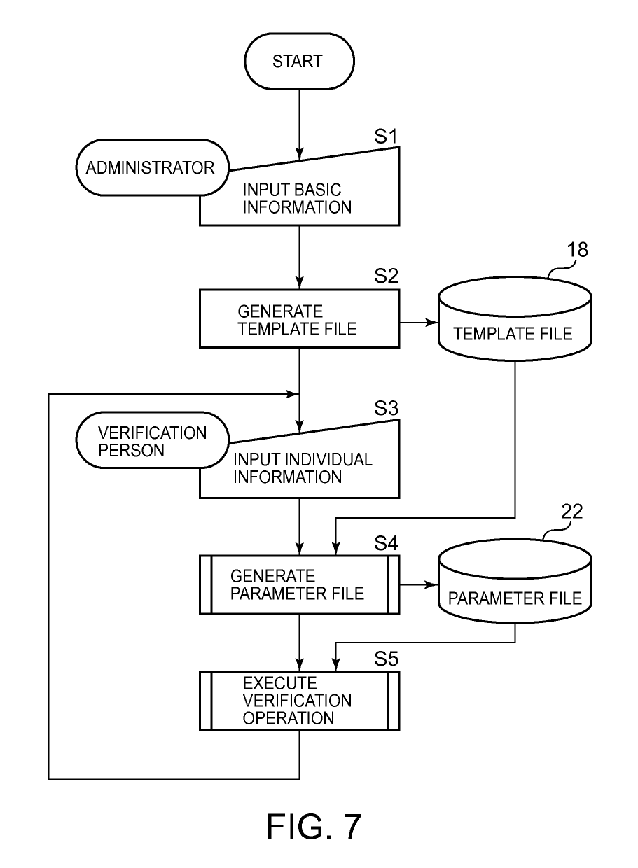

Referring to FIGS. 1 and 7, the input device 12 receives input of the basic information (the test group basic information 181 and the test case basic information 182) in accordance with the manipulation by the administrator (S1). The text editor 16 generates the template file 18 including the inputted basic information (S2).

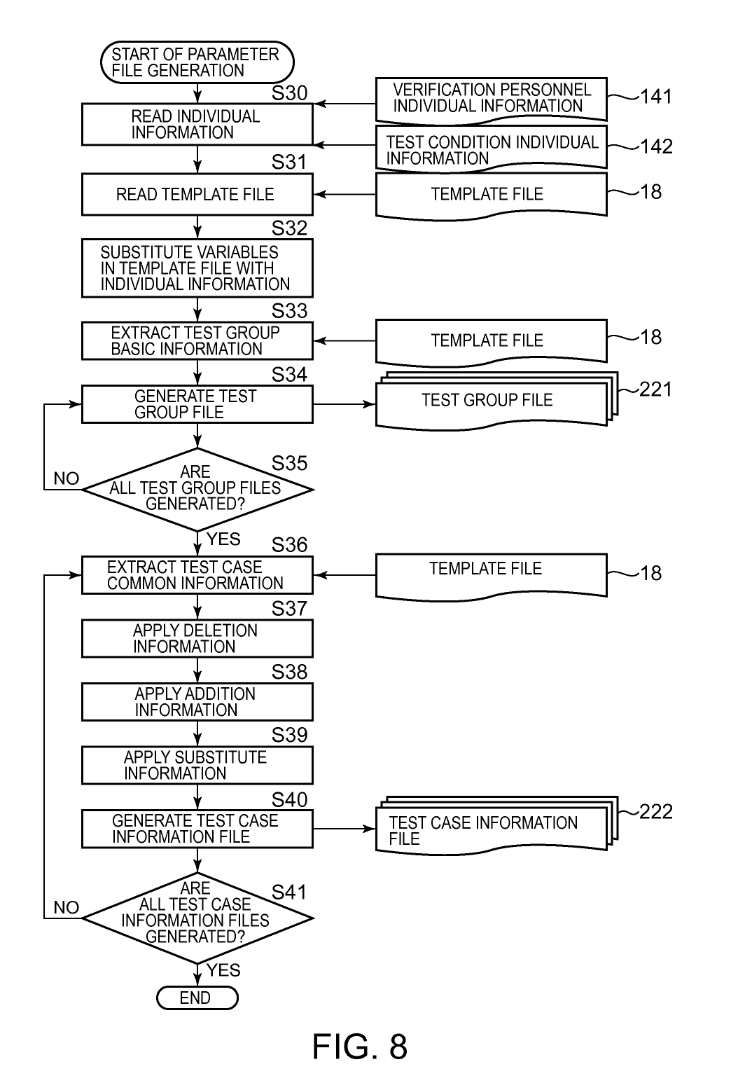

Subsequently, the input device 14 receives input of the individual information (the verification person individual information 141 and the test condition individual information 142) in accordance with the manipulation by the verification person (S3). The parameter file automatic generation program 20 generates the parameter file 22 by reading the basic information from the template file 18, and adding the inputted individual information to the basic information. FIG. 8 illustrates the details thereof.

Referring to FIG. 8, the parameter file automatic generating program 20 reads the verification person individual information 141 and the test condition individual information 142 inputted by the input device 14 (S30), and further reads the template file 18 (S31). The parameter file automatic generating program 20 then substitutes variables in the template file 18 (such as $(PARM), $(BASE) or the like in FIG. 3) with the read pieces of individual information 141 and 142 (S32).

Subsequently, the parameter file automatic generating program 20 extracts the test group basic information 181 from the template file 18 (S33), and generates the plurality of test group files 221 (S34).

After all the test group files 221 are generated (YES at S35), the parameter file automatic generating program 20 extracts the test case common information 183 from the template file 18 (S36). The parameter file automatic generating program 20 then applies the deletion information of the template file 18 to delete predetermined information from the test case common information 183 (S37). The parameter file automatic generating program 20 also applies the addition information of the template file 18 to add the predetermined information to the test case common information 183 (S38). The parameter file automatic generating program 20 further applies the substitute information of the template file 18 to substitute the predetermined information in the test case common information 183 with different predetermined information (S39). Thereby, the parameter file automatic generating program 20 generates the test case information file 222 (S40).

The parameter file automatic generating program 20 repeats steps S36 through 40 described above until the generation of all the test case information files 222 is completed (S41).

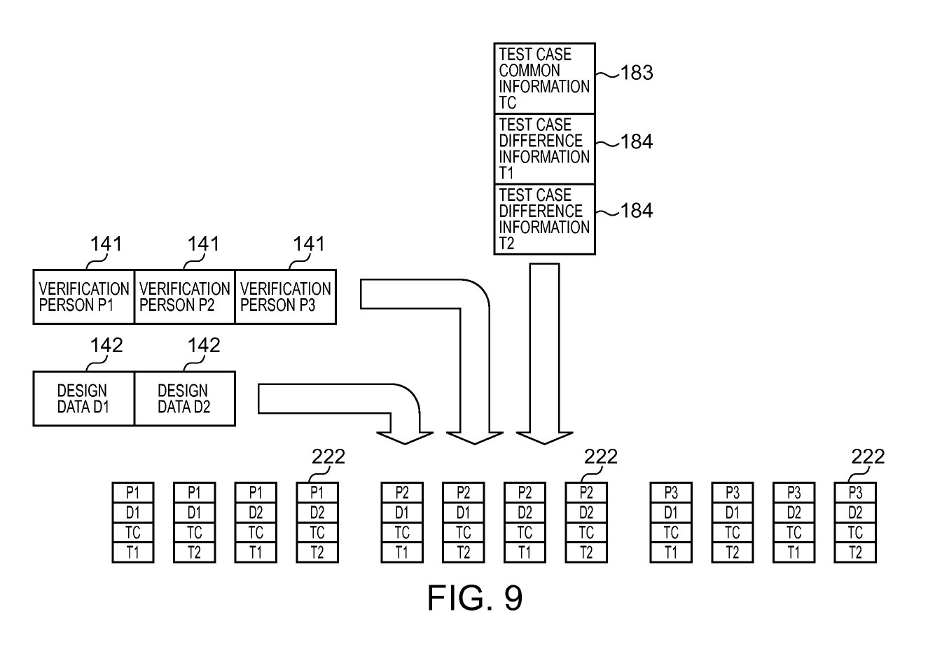

For example, in the case where there are two test cases, as illustrated in FIG. 9, the template file 18 includes one test case common information 183 (TC) and two pieces of test case difference information 184 (T1, T2). Moreover, in the case where there are three verification persons, three pieces of verification person individual information 141, specifically, three pieces of path information P1 through P3 for indicating the location of the working directory, are inputted. Furthermore, when there are two design data, two pieces of test condition individual information 142, specifically, two pieces of path information D1 and D2 for indicating the location of the design data, are inputted. In this case, while the parameter file automatic generating program 20 can generate twelve kinds of test case information files 222, it actually generates any of the test case information file 222 and stores it in the parameter file 22.

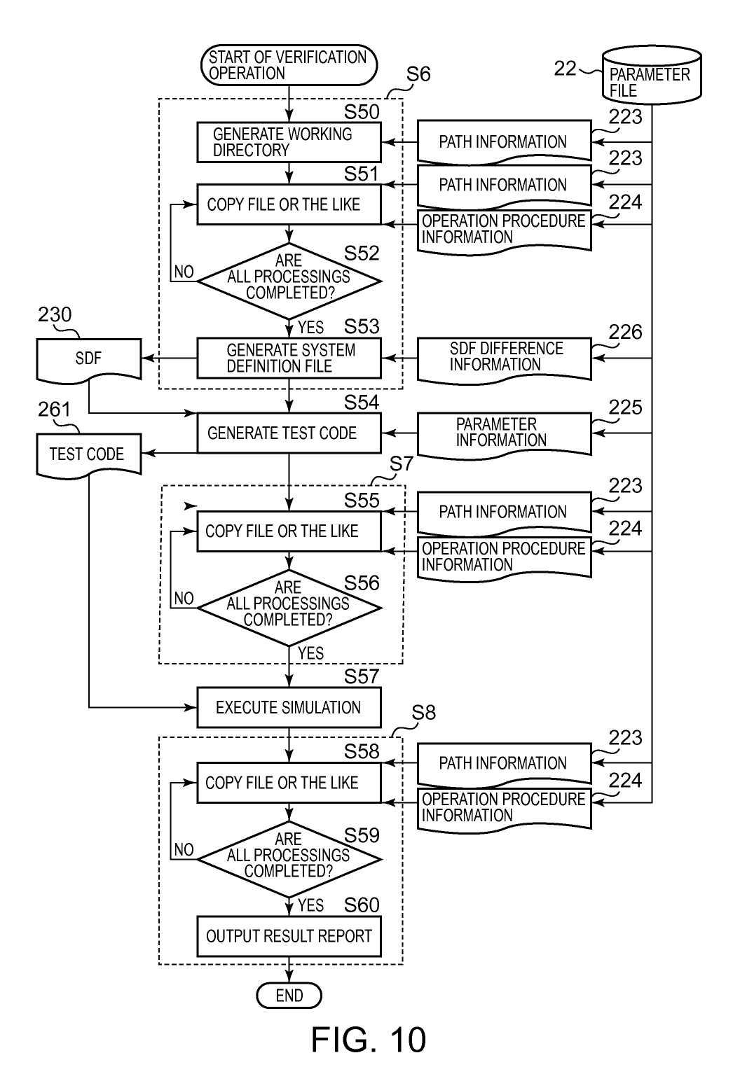

The verification operation executing program 24 then automatically executes the verification operation in accordance with the parameter file 22 by running the TOS 26 and the HDL simulator 28. FIG. 10 illustrates the details thereof.

Referring to FIG. 10, the verification operation executing program 24 executes, in summary, the pre-processing of the test code generation S6, the processing of the test code generation S54, the pre-processing of the simulation S7, the processing of the simulation S57, and the post-processing of the simulation S8, in this order.

In the pre-processing of the test code generation S6, the verification operation executing program 24 reads one test case information file 222 to be the target from the parameter file 22 to thereby generate the working directory based on the path information 223 therein (S50). Subsequently, the verification operation executing program 24 executes the predetermined processing (part of <pre-compile> to </pre-compile>; such as copying the file needed in the simulation to the working directory) based on the path information 223 and the operation procedure information 224 in the test case information file 222 (S51). After all the predetermined process are completed (YES at S52), the verification operation executing program 24 newly generates the system definition file 230 by applying the system definition file (SDF) difference information 226 in the test case information file 222 to the system definition file used as the base (S53).

After the pre-processing of the test code generation S6, the verification operation executing program 24 provides the generated system definition file 230 and the test code generation/simulation parameter information 225 in the test case information file 222 to the TOS 26, and the TOS 26 generates the test code 261 by compiling them (S54).

Next, in the pre-processing of the simulation S7, the verification operation executing program 24 executes the predetermined processing (part of <pre-simulation> to </pre-simulation>; such as copying the specified file to the specified directory) based on the path information 223 and the operation procedure information 224 in the test case information file 222 (S55). After all the predetermined process are completed (YES at S56), the verification operation executing program 24 proceeds to the next step.

After the pre-processing of the simulation S7 is completed, the verification operation executing program 24 provides the input to the HDL simulator 28 with the test code 261 generated by the TOS 26 to then execute the simulation (S57).

Next, at the post-processing of the simulation S8, the verification operation executing program 24 executes the predetermined processing (such as copying the specified file to the specified directory) based on the path information 223 and the operation procedure information 224 in the test case information file 222 (S58). After all the predetermined process are completed (YES at S59), the verification operation executing program 24 proceeds to the next step.

Finally, the test result is summarized based on the result file 281 outputted by the HDL simulator 28, and a simulation result report is outputted to a report directory (S60).

Referring again to FIG. 7, the verification operation supporting system 10 repeats the process S3 through S5 described above for every test phase.

As described above, according to the embodiment of the present invention, only by the fact that the administrator inputs the test group basic information 181 and the test case basic information 182 to generate the template file 18, using the text editor 16 and each verification person inputs the verification person individual information 141 and the test condition individual information 142, the parameter file automatic generating program 20 generates the test case information file 222 for every test case, the TOS 26 is caused to generate the test code 261 in accordance with each test case information file 222, and the HDL simulator 28 is caused to execute the simulation. As a result, a series of complicated verification operations including the generation of the test code 261 are integrated, allowing overall automation, not partial automation, for the entire verification operation.

In addition, since the administrator describes the basic contents of the verification operation in the template file 18 and centrally manages it, each verification person does not need to know the details. Moreover, when modification is necessary for the verification information, it is carried out only by the administrator changing the template file, so that each verification person does not need to know the change of the operation contents. For example, even when the configuration files to be read by the HDL simulator 28 are increased by one, each verification person does not need to know that at all. When the template file 18 is updated, each verification person can obtain the parameter file 22 in accordance with his/her own working environment or test condition, only by regenerating the parameter file 22.

In addition, since the test case basic information 182 is divided into the test case common information 183 and the test case difference information 184, the test case common information 183 does not need to be described repeatedly, allowing redundant information to be reduced. Moreover, only by changing part of the test case common information 183, it can be reflected to all the test case information files 222.

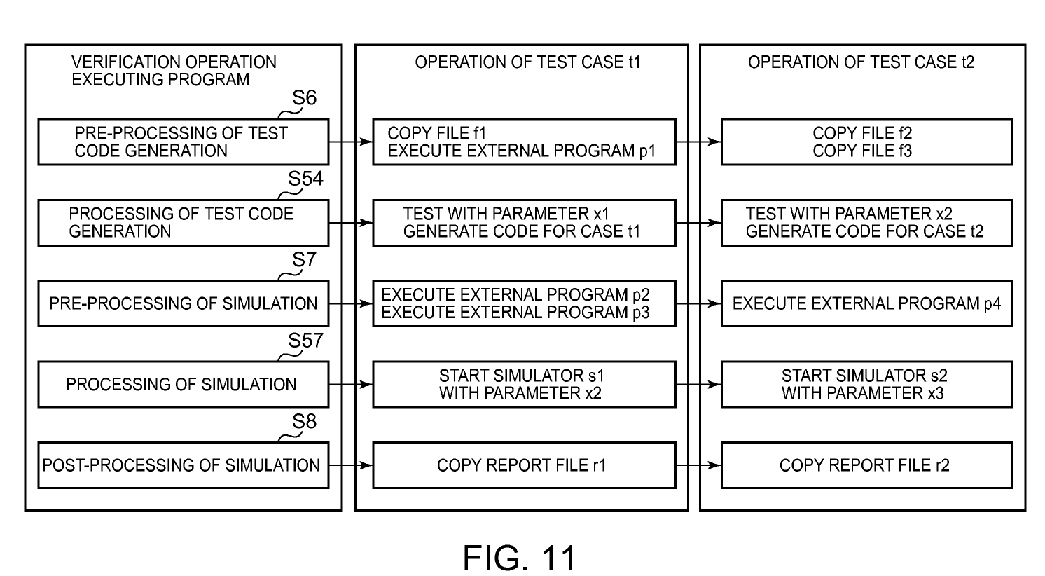

Furthermore, the verification operation executing program 24 deals with the respective parts in the test case information file 222 not only as only data but also as the operation procedure. In other words, the test case information file 222 serves not only as only data file but also as part of the verification operation executing program 24. For that reason, the content of the verification operation can be changed for every test case by changing the test case difference information 184. FIG. 11 illustrates an example thereof.

While one embodiment of the present invention has been illustrated, the present invention is not limited to the embodiment described above. Although the embodiment described above is premised on that all the verification operation supporting system 10 is established along with the compiler, such as the TOS 26, and the HDL simulator 28 in one business place of an SOC design contractor, the input device for the administrator 12, the input device for the verification person 14, and the verification operation executing program 24 may be established along with the compiler, such as the TOS 26, and the HDL simulator 28 in each business place of the SOC design contractor while establishing the text editor 16 and the parameter file automatic generating program 20 in an SOC design support supplier. In this case, a certain SOC design support supplier acquires the basic information and the individual information from each SOC design contractor, and sends back the parameter file 22 generated (produced) by the parameter file automatic generating program 20 to each SOC design contractor. In addition, hardware resources or software resources, such as the input device for the administrator 12, the input device for the verification person 14, the text editor 16, the template file 18, the parameter file automatic generating program 20, the parameter file 22, the verification operation executing program 24, the TOS 26, and the HDL simulator 28, are not necessary to be established on a single computer, but may be separately established on a plurality of computers connected with a network.

While the embodiment of the invention has been described above, the embodiment described above is only exemplification for carrying out the present invention. Therefore, the present invention, without being limited to the embodiment described above, can be carried out by appropriately modifying the embodiment described above without departing from the spirit of the present invention.

The invention claimed is:

1. A verification operation supporting system for supporting verification operation to verify one or more design data by one or more test cases using a simulator, the system comprising:
a basic information input configured for receiving input of basic information necessary to specify the test case;
a template file generator configured for generating a template file including the basic information inputted by the basic information input;
a individual information input configured for receiving input of individual information necessary to specify an item other than the test case;
a parameter file generator configured for generating a parameter file necessary for the verification operation by reading the basic information from the template file and adding the individual information inputted by the individual information input to the basic information; and
a verification operation executor configured for executing the verification operation in accordance with the parameter file while running the simulator.

2. The verification operation supporting system according to claim 1, wherein the basic information includes:
test case information common to a plurality of test cases and;
a plurality of test case difference information, each test case difference information being different for every test case.

3. The verification operation supporting system according to claim 2, wherein the parameter file generator generates a test case information file for each test case by adding the test case difference information corresponding to each test case to the test case common information, and the parameter file includes a plurality of test case information files corresponding to a plurality of test cases.

4. The verification operation supporting system according to claim 1, wherein
the parameter file includes a plurality of test case information files corresponding to a plurality of test cases, and the individual information includes path information for indicating a location of the design data to be verified, and wherein
the parameter file generator generates the test case information file for each test case by adding the path information inputted by the individual information input, and each of the test case information files includes the path information.

5. The verification operation supporting system according to claim 1, wherein
each of the test case information files includes operation procedure information which describes an operation to be executed before the generation of the test code to be given to the simulator, and an operation to be executed before and after the simulation by the simulator, and wherein
the verification operation executor is configured to:
execute the operation described in the operation procedure information before the generation of the test code,
cause a compiler to generate the test code,
execute the operation described in the operation procedure information before the simulation,
cause the simulator to execute the simulation, and
execute the operation described in the operation procedure information after the simulation.

6. A verification operation supporting method which can be executed by a computer for supporting verification operation to verify one or more design data by one or more test cases using a simulator, the method comprising the steps of:
receiving input of basic information necessary to specify the test case;
generating a template file including the inputted basic information;
receiving input of individual information necessary to specify an item other than the test case;
generating a parameter file necessary for the verification operation by reading the basic information from the template file and adding the inputted individual information to the basic information; and
executing the verification operation in accordance with the parameter file while running the simulator.

7. The verification operation supporting method according to claim 6, wherein
the basic information includes test case common information common to a plurality of test cases, and a plurality of pieces of test case difference information different for every test case.

8. The verification operation supporting method according to claim 7, wherein the step of generating the parameter file generates a test case information file for each test case by adding the test case difference information corresponding to each test case to the test case common information, and the parameter file includes a plurality of test case information files corresponding to a plurality of test cases.

9. The verification operation supporting method according to claim 6, wherein
the parameter file includes a plurality of test case information files corresponding to a plurality of test cases, and the individual information includes path information for indicating a location of the design data to be verified, and wherein
the step of generating the parameter file generates the test case information file for each test case by adding the path information inputted by the individual information input means, and each of the test case information files includes the path information.

10. The verification operation supporting method according to claim 6, wherein
each of the test case information files includes operation procedure information which describes an operation to be executed before the generation of the test code to be given to the simulator and an operation to be executed before and after the simulation by the simulator, and wherein
the step of executing the verification operation includes the steps of:
executing the operation described in the operation procedure information before the generation of the test code,
causing a compiler to generate the test code,
executing the operation described in the operation procedure information before the simulation,
causing the simulator to execute the simulation, and
executing the operation described in the operation procedure information after the simulation.

11. A verification operation supporting program product for supporting verification operation to verify one or more design data by one or more test cases using a simulator, the program product causing a computer to execute the steps of:
receiving input of basic information necessary to specify the test case;
generating a template file including the inputted basic information;
receiving input of individual information necessary to specify an item other than the test case;
generating a parameter file necessary for the verification operation by reading the basic information from the template file and adding the inputted individual information to the basic information; and
executing the verification operation in accordance with the parameter file while running the simulator.

12. The verification operation supporting program product according to claim 11, wherein the basic information includes test case common information common to a plurality of test cases, and a plurality of test case difference information different for every test case.

13. The verification operation supporting program product according to claim 12, wherein the step of generating the parameter file generates a test case information file for each test case by adding the test case difference information corresponding to each test case to the test case common information, and the parameter file includes a plurality of test case information files corresponding to a plurality of test cases.

14. The verification operation supporting program product according to claim 11, wherein
the parameter file includes a plurality of test case information files corresponding to a plurality of test cases, and the individual information includes path information for indicating a location of the design data to be verified, and wherein
the step of generating the parameter file generates the test case information file for each test case by adding the path information inputted by the individual information input means, and each of the test case information files includes the path information.

15. The verification operation supporting program product according to claim 11, wherein
each of the test case information files includes operation procedure information which describes an operation to be executed before the generation of the test code to be given to the simulator and an operation to be executed before and after the simulation by the simulator, and wherein
the step of executing the verification operation includes the steps of:
executing the operation described in the operation procedure information before the generation of the test code,
causing a compiler to generate the test code,
executing the operation described in the operation procedure information before the simulation,
causing the simulator to execute the simulation, and
executing the operation described in the operation procedure information after the simulation.
